(19) United States
(12) Patent Application Publication
(10) Pub. No.: US 2002/0026859 A1
(43) Pub. Date: Mar. 7, 2002

(54) Plug wrench

(76) Inventor: Shoji Suzuki, Kakegawa-Shi (JP)

Correspondence Address: JACOBSON, PRICE, HOLMAN & STERN, 400 SEVENTH STREET, N.W., WASHINGTON, DC, 20004, US

(21) Appl. No.: 09/986,615

(22) Filed: Nov. 9, 2001

(30) Foreign Application Priority Data
May 31, 2000 (TW) 90113119

(51) Int. Cl. B25B 13/06

(52) U.S. Cl. 81/121.1

(57) ABSTRACT

The present invention provides a plug wrench in which a distal end of a plug fixing member disposed within the plug wrench is not caught at the time of attaching/detaching a spark plug, thus enabling to prevent damage and breakage. A groove is formed in a plug fitting recessed portion so that the distal end of the plug fitting member is fitted and concealed in the groove.

### BACKGROUND OF THE INVENTION

This invention relates to a wrench for fixing a sparkplug which is to be attached to an engine case of an internal combustion engine.

As a device capable of resolving the shortcomings involved in the conventional plug wrenches in which magnet, rubber or the like is used as a member for fixing a plug, the present applicant has already disclosed a plug wrench in Japanese Patent Application Laid-Open No. H11-267979 (Taiwan Patent Publication No. 372212), which is used for a fixing member of a plate spring having a bent portion.

However, the continuous use of the above plug wrench at a site reveals the following shortcomings. At the time of attaching/detaching the spark plug, a distal end of the bent portion is liable to be caught and turned up after repeated use, with the result that its function is lost.

### SUMMARY OF THE INVENTION

It is, therefore, an object of the present invention to provide an improved plug wrench with a higher performance which is capable of obviating the above-mentioned shortcomings inherent in the conventional plug wrenches, and in which a spark plug can more smoothly be attached/detach, a plate spring can maintain its good function as a fixing member.

According to the present invention, there is provided a plug wrench comprising a cylindrical wrench main body, a control portion provided on one end of the wrench main body and to which a distal end rectangular portion of a rotation control handle is fitted, a plug fitting recessed portion formed in the other end of the wrench main body and to which a plug is fitted, a plug fixing member fitted in the fitting recessed portion, the plug fixing member being comprised of a ring-shaped surface portion attached to the bottom of the fitting recessed portion and a plurality of bent plate springs raised from an edge part of the ring-shaped surface portion and contacted with a peripheral surface of the fitting recessed portion, a guide portion made of a yellow copper material, the guide portion being formed on a bottom portion of the fitting recessed portion and being contacted with the plug, and a groove formed in a plug fitting recessed portion so that the distal ends of the plate springs are fitted and concealed in the groove. Owing to this construction, the distal ends of the plate springs are not caught at the time of attaching/detaching the spark plug.

### BRIEF DESCRIPTION OF THE DRAWINGS

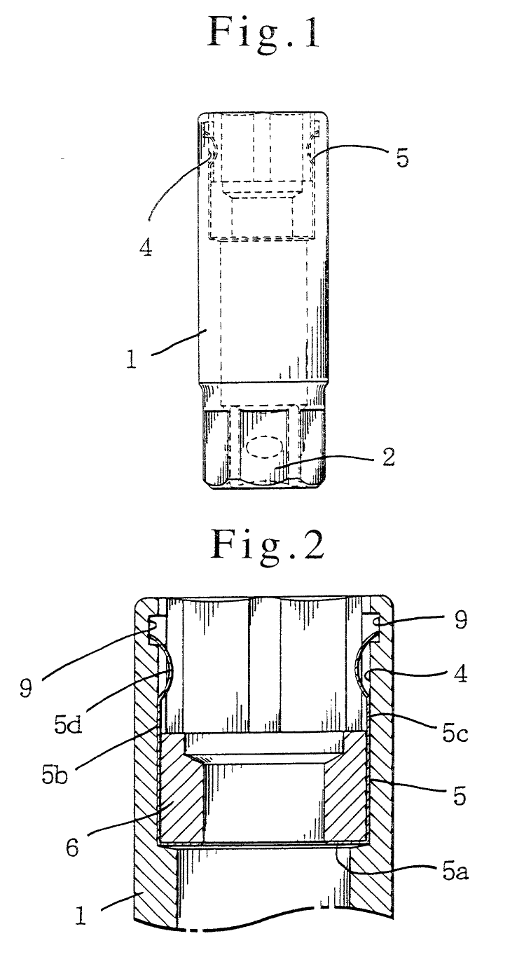

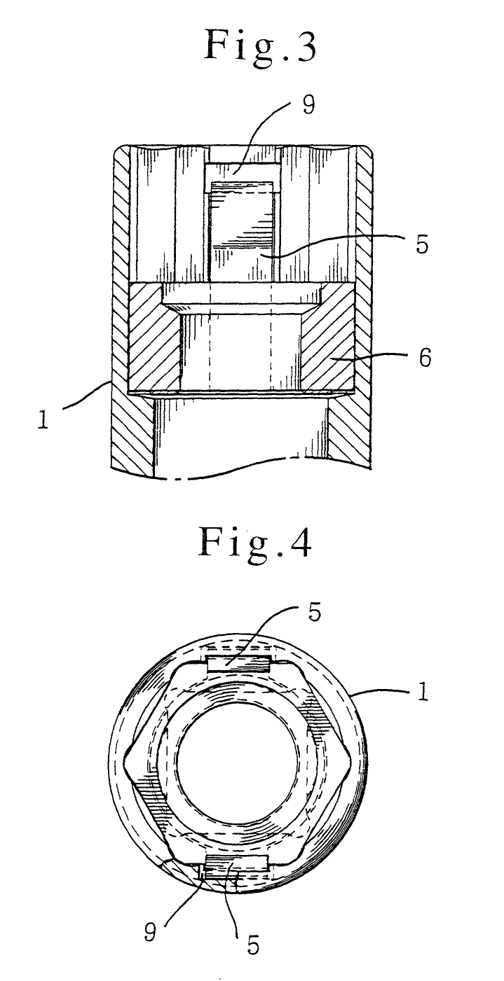

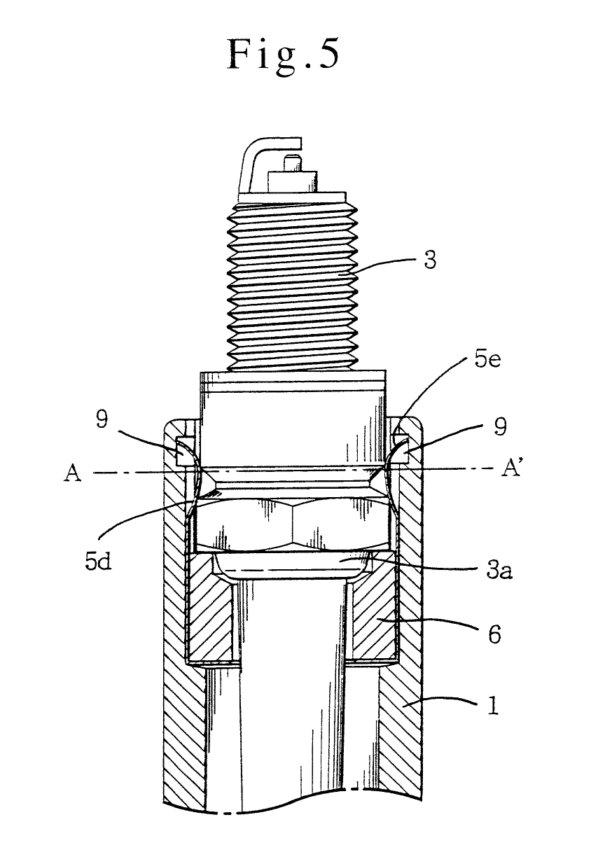

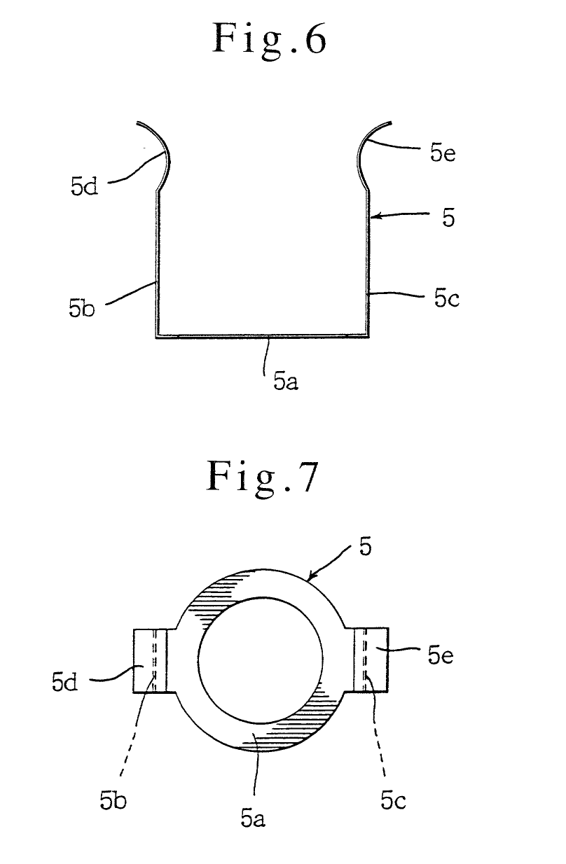

The drawings show a specific embodiment of a plug wrench according to the present invention, wherein FIG. 1 is a front view, FIG. 2 is an enlarged front sectional view of an important portion, FIG. 3 is an enlarged side sectional view of the important portion, FIG. 4 is an enlarged plan sectional view of the important portion, FIG. 5 is a sectional view of the important portion with a plug fitted thereto, FIG. 6 is a front view of a bent plate spring used in the plug wrench of the present invention, and FIG. 7 is a plan view of FIG. 6.

### DETAILED DESCRIPTION OF THE PREFERRED EMBODIMENT

In the drawings, reference numeral 1 denotes a cylindrical wrench main body. One end of the wrench main body 1 is provided with a rotation control handle (not shown) rectangular control portion 2 and the other end is provided with a fitting recessed portion 4 into which a plug 3 is fitted. Grooves 9, 9 are provided adjacent to an opening end of the fitting recessed portion 4. A fixing member 5 of the plug 3 is fitted to a bottom of the fitting recessed portion 4.

The fixing member 5, as shown in FIGS. 6 and 7, is comprised of a ring-shaped surface portion 5a and raised bent plate springs 5b, 5c which are made of a stainless steel material and disposed at left and right parts of a peripheral edge of the ring-shaped surface portion 5a. Distal ends of the bent plate springs 5b, 5c are inserted and concealed in the grooves 9, 9 with the ring-like surface portion 5a abutted with the bottom of the fitting recessed portion 4 and with the bent plate springs 5b, 5c contacted with a peripheral wall of the fitting recessed portion 4, so that elastic bent portions 5d, 5e are defined at upper half portions of the bent plate springs 5b, 5c. The bent plate springs may be provided at three locations.

Reference numeral 6 denotes a brass guide member fitted to a bottom surface of the fixing member 5. A contact portion 3a of the plug 3 inserted for attachment into the main body 1 is contacted directly with the guide member 6. Since the brass (yellow copper) having a low hardness exhibits a cushioning function, an inner surface of the guide member 6 serves as a guide for the plug 3.

According to the present invention, since the distal ends of the bent plate springs 5b, 5c are concealed in the grooves 9, 9, spark plug 3 can smoothly be attached/detached without allowing the distal ends of the plate springs to be caught. This prevents the damage and breakage of the plate springs and serves to maintain the function as a fixing member for a long period of time.

If the plate springs are made of a hard material, they are liable to be broken at the time of attaching/detaching the spark plug. In contrast, if the plate springs are made of a soft material, they are liable to be deformed. Thus, the plate springs made of a hard material/soft material are not suitable. In order to further enhance the effect of the present invention, it is preferable that the plate springs are made of a stainless steel material having a proper degree of hardness.

What is claimed is:

1. A plug wrench comprising a cylindrical wrench main body, a control portion provided on one end of said wrench main body and to which a distal end rectangular portion of a rotation control handle is fitted, a plug fitting recessed portion formed in the other end of said wrench main body and to which a plug is fitted, a fixing member made of a metal thin plate and fitted in said fitting recessed portion, a groove formed in said fitting recessed portion and to which a distal end of said fixing member is inserted, and a guide portion made of a material having a low degree of hardness such as a yellow copper material, said guide portion being formed on a bottom portion of said fitting recessed portion and being contacted with said plug.

2. A plug wrench according to claim 1, wherein said fixing member is comprised of a ring-shaped surface portion attached to the bottom of said fitting recessed portion and a plurality of bent plate springs raised from an edge part of said ring-shaped surface portion and contacted with a peripheral surface of said fitting recessed portion.

3. A plug wrench according to claim 1, wherein said guide member is made of a brass material.

4. A plug wrench according any one of claims 1 through 3, wherein said metal thin plate-made fixing material is made of a stainless steel material.
